(19) United States
(12) Patent Application Publication
(10) Pub. No.: US 2005/0072703 A1
(43) Pub. Date: Apr. 7, 2005

(54) Tool receiving device

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/924,222

(22) Filed: Aug. 23, 2004

(30) Foreign Application Priority Data
Oct. 7, 2003 (TW) 92127748

(51) Int. Cl. H01R 13/62

(52) U.S. Cl. 206/373; 206/349

(57) ABSTRACT

A tool receiving device includes a first member made of a deformable material, a second member made of a deformable material, and at least one retaining member separate from the first member and the second member. The first member includes at least one tool receiving compartment and at least one groove in a side thereof. The second member includes at least one hole that is aligned with the groove when the second member is engaged with the first member and thus covers the tool receiving compartment and the groove. The retaining member can be mounted into the hole of the second member and the groove of the first member and is turnable from between a non-retaining position allowing disengagement of the second member from the first member and a retaining position not allowing disengagement of the second member from the first member.

### BACKGROUND OF THE INVENTION

1. Field of the Invention

The present invention relates to tool receiving devices of the type including a first casing for receiving tools and a second casing for covering the first casing.

2. Description of the Related Art

FIG. 1 of the drawings illustrates a conventional tool receiving device and

FIG. 2 is a sectional view of the tool receiving device in FIG. 1. The tool receiving device includes a bottom casing 1 and a cover casing 2 for covering the bottom casing 1. The bottom casing 1 includes a plurality of compartments 4 for receiving tools 3 (e.g., wrenches) and a plurality of recesses 5 each having a square section. The cover casing 2 includes a plurality of protrusions 6 integrally formed on an inner face thereof. Each protrusion 6 has a diameter slightly greater than a length of a side of each recess 5. As illustrated in FIG. 2, the respective protrusions 6 are force-fitted into the respective recesses 5 to securely retain the cover casing 2 on the bottom casing 1. Nevertheless, disengagement of the cover casing 2 from the bottom casing 1 is difficult if the engagement therebetween is too tight. The user has to apply a relatively large force to separate the cover casing 2 and the bottom casing 1 from each other, which is inconvenient and might cause injury to the fingers of the user. On the other hand, if the engagement between the cover casing 2 and the bottom casing 1 is not tight enough, the cover casing 2 might be disengaged from the bottom casing 1 due to impact during transport, vibrations during display, or falling of the tool receiving device, resulting in scattering of the tools 3.

### SUMMARY OF THE INVENTION

In accordance with an aspect of the present invention, a tool receiving device comprises a first member made of a deformable material, a second member made of a deformable material, and at least one retaining member separate from the first member and the second member. The first member includes at least one tool receiving compartment and at least one groove in a side thereof. The second member includes at least one hole that is aligned with the groove when the second member is engaged with the first member and thus covers the tool receiving compartment and the groove.

The retaining member can be mounted into the hole of the second member and the groove of the first member and is turnable from between a non-retaining position allowing disengagement of the second member from the first member and a retaining position not allowing disengagement of the second member from the first member.

In an embodiment of the invention, the second member includes a hollow protrusion extending from a perimeter wall delimiting the hole of the second member. The hollow protrusion is received in the groove of the first member when the second member is engaged with the first member. A perimeter wall of the hollow protrusion of the second member and a perimeter wall delimiting the groove of the first member deform outward and in friction contact with each other when the retaining member is in the retaining position.

The retaining member includes four sides and four corners. A length of each side of the retaining member is not greater than that of a side of the hole of the second member. A distance between two of the corners that are diagonally disposed is greater than the length of the side of the hole of the second member and smaller than a diagonal length of the hole of the second member. The retaining member includes a turn piece on a top side thereof.

In another embodiment of the invention, the retaining member includes a circumference and at least one pair of diametrically disposed protrusions formed on the circumference and defining a maximum diameter. A diameter of the circumference of the retaining member is not greater than a length of a side of the hole of the second member. The maximum diameter of the retaining member is greater than the length of the side of the hole of the second member and smaller than a diagonal length of the hole of the second member. The retaining member includes a slot in a top side thereof.

In a further embodiment of the invention, the retaining member includes an enlarged first end having a diameter greater than a length of a side of the hole. The retaining member further includes a second end that is received in the groove of the first member. The second end of the retaining member includes four sides and four corners. A length of each side of the retaining member is not greater than that of the side of the groove of the first member. A distance between two of the corners that are diagonally disposed is greater than the length of the side of the groove of the first member and smaller than a diagonal length of the groove of the first member. The retaining member includes a turn piece on a top side thereof.

In still another embodiment of the invention, the retaining member includes an enlarged first end having a diameter greater than a length of a side of the hole. The retaining member further includes a second end that is received in the groove of the first member. The second end of the retaining member includes a circumference and at least one pair of diametrically disposed protrusions formed on the circumference and defining a maximum diameter. A diameter of the circumference is not greater than the length of a side of the groove of the first member. The maximum diameter of the retaining member is greater than the length of the side of the groove of the first member and smaller than a diagonal length of the groove of the first member. The enlarged first end of the retaining member includes a cruciform slot in a top face thereof.

In an alternative embodiment, the retaining member includes an extension to allow manual turning.

The first member and the second member may be plastic casings. The groove of the first member and the hole of the second member are preferably square.

Preferably, an outer perimeter of the first member is bonded with an outer perimeter of the second member by high frequency wave heat pressing.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional tool receiving device.

FIG. 2 is a sectional view of the tool receiving device in FIG. 1.

FIG. 3 is an exploded perspective view of a first embodiment of the tool receiving device in accordance with the present invention.

FIG. 4 is a top view of the tool receiving device in FIG. 3.

FIG. 5 is a sectional view taken along plane 5-5 in FIG. 4.

FIG. 6 is a top view similar to FIG. 4, wherein the retaining elements are moved to a retaining position.

FIG. 7 is a sectional view taken along plane 7-7 in FIG. 6.

FIG. 8 is an exploded perspective view of a second embodiment of the tool receiving device in accordance with the present invention.

FIG. 9 is a top view of the tool receiving device in FIG. 8.

FIG. 10 is a sectional view taken along plane 10-10 in FIG. 9.

FIG. 11 is a top view similar to FIG. 9, wherein the retaining elements are moved to a retaining position.

FIG. 12 is a sectional view taken along plane 12-12 in FIG. 11.

FIG. 13 is an exploded perspective view of a third embodiment of the tool receiving device in accordance with the present invention.

FIG. 14 is a top view of the tool receiving device in FIG. 13.

FIG. 15 is a sectional view taken along plane 15-15 in FIG. 14.

FIG. 16 is a top view similar to FIG. 14, wherein the retaining elements are moved to a retaining position.

FIG. 17 is a sectional view taken along plane 17-17 in FIG. 16.

FIG. 18 is an exploded perspective view of a fourth embodiment of the tool receiving device in accordance with the present invention.

FIG. 19 is a top view of the tool receiving device in FIG. 18.

FIG. 20 is a sectional view taken along plane 20-20 in FIG. 19.

FIG. 21 is a top view similar to FIG. 19, wherein the retaining elements are moved to a retaining position.

FIG. 22 is a sectional view taken along plane 22-22 in FIG. 21.

FIG. 23 is a perspective view of a fifth embodiment of the tool receiving device in accordance with the present invention.

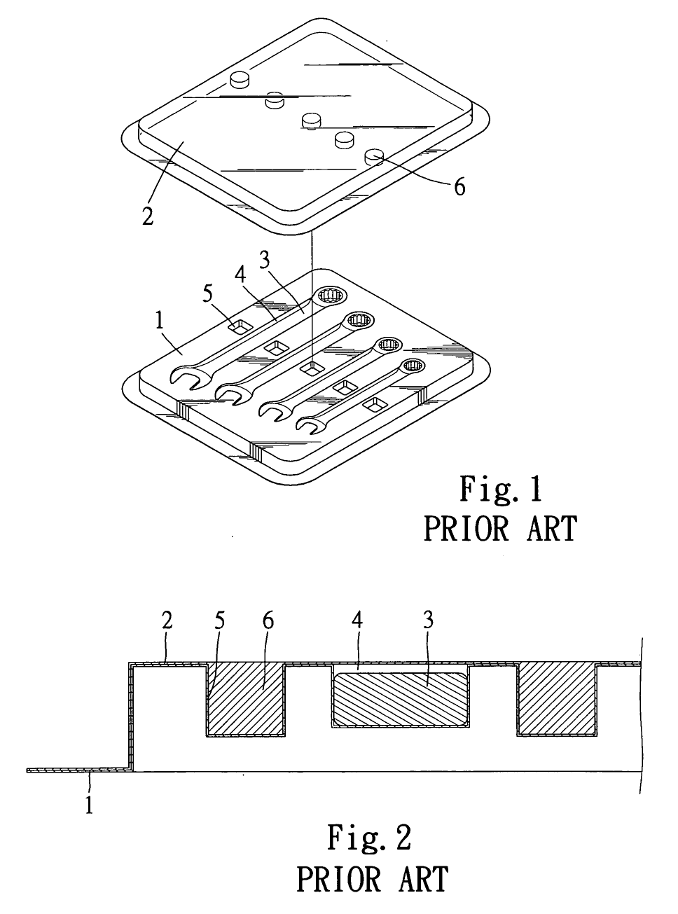

### DETAILED DESCRIPTION OF THE PREFERRED EMBODIMENTS

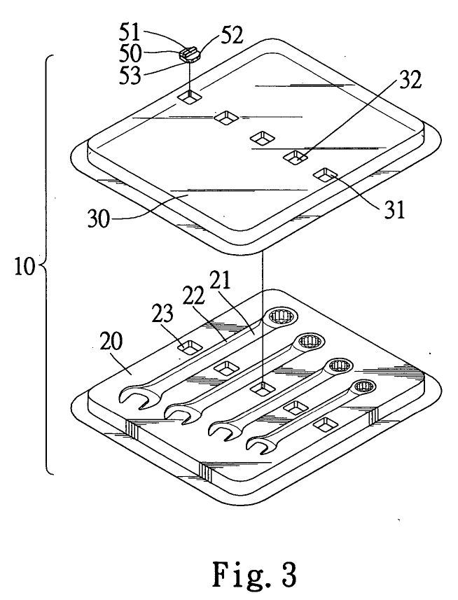

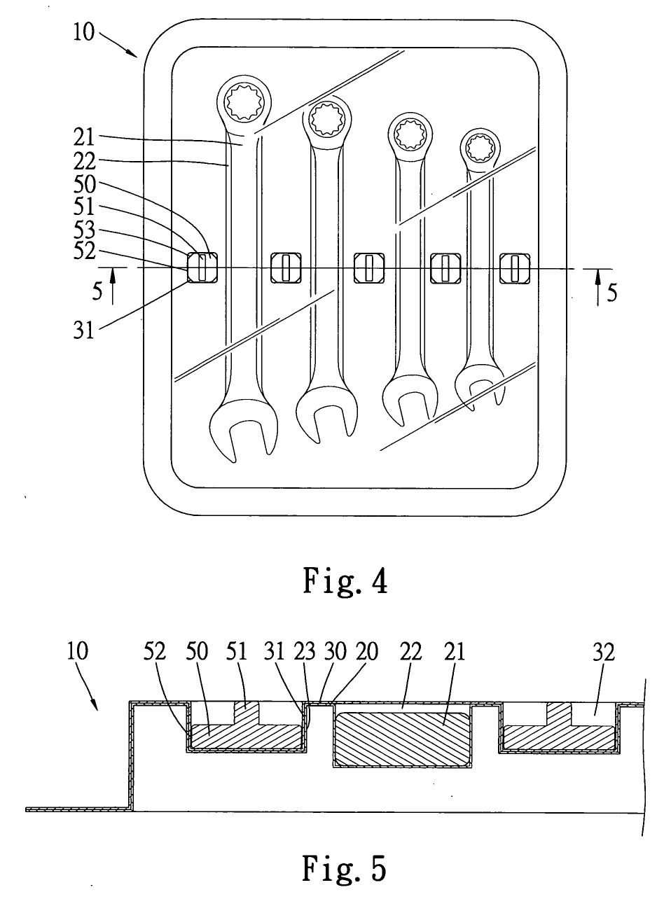

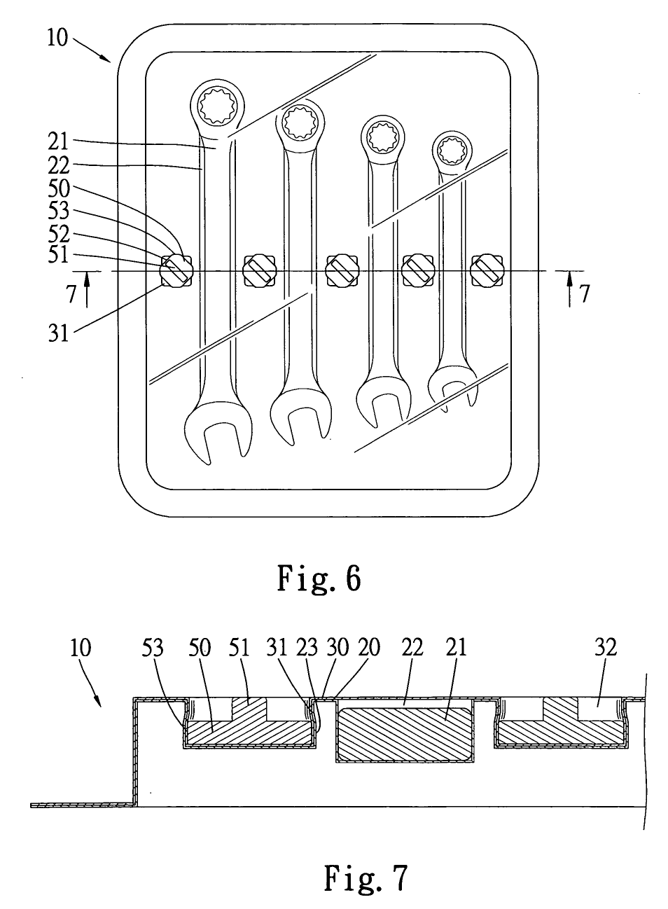

FIG. 3 is an exploded perspective view of a first embodiment of the tool receiving device 10 in accordance with the present invention. FIG. 4 is a top view of the tool receiving device 10 in FIG. 3. FIG. 5 is a sectional view taken along plane 5-5 in FIG. 4. FIG. 6 is a top view similar to FIG. 4, wherein the retaining elements are moved to a retaining position. FIG. 7 is a sectional view taken along plane 7-7 in FIG. 6.

The first embodiment of the tool receiving device 10 in accordance with the present invention includes a first member 20, a second member 30 for covering the first member 20, and a plurality of retaining members 50 for retaining the second member 30 in place. The first member 20 is made from a plastic material and includes a plurality of compartments 22 for receiving tools 21 (such as wrenches) and a plurality of grooves 23. In this embodiment, the first member 20 is a plastic thin casing formed by means of injection molding. Each groove 23 has a square section. Preferably, the grooves 23 and the compartments 22 are alternately disposed.

The second member 30 is made from a plastic material and includes a plurality of hollow protrusions 31 on a side thereof that cases the first member 10. Each hollow protrusion 31 has a square section with a length slightly smaller than that of the associated groove 23. Further, each hollow protrusion 31 includes a hole 32 facing away from the first member 20. Each hole 32 has a square section. In this embodiment, the second member 30 is a plastic thin casing formed by means of injection molding. Each hole 32 is a blind hole delimited by an end wall (not labeled). Alternatively, each hole 32 is a through-hole, with the hollow protrusion 31 extending from a perimeter wall delimiting the through-hole 32.

In this embodiment, each retaining member 50 includes a turn piece 51 on a top side thereof for the user's grip. Further, each retaining member 50 includes four sides 52 and four corners 53. Preferably, the four sides 52 have the same length, and each corner 53 is chamfered. The length of each side 52 is not greater than that of the side of the hole 32 of the associated hollow protrusion 31. Nevertheless, the distance between two diagonally opposed corners 53 of the retaining member 50 is greater than the length of the side of the hole 32 of the associated hollow protrusion 31 and smaller than a diagonal length of the hole 32 of the associated hollow protrusion 31.

As illustrated in FIGS. 4 and 5, the respective retaining members 50 are placed into the holes 32 of the respective hollow protrusions 31, with four chamfered corners 53 of each retaining member 50 being received in the four corners of the hole 32 of the associated hollow protrusion 31. The perimeter wall delimiting the hole 32 of each hollow protrusion 31 and the perimeter wall delimiting the associated groove 23 are not deformed, as the distance between two diagonally opposed corners 53 of the retaining member 50 is smaller than the diagonal length of the hole 32 of the associated hollow protrusion 31.

Referring to FIGS. 6 and 7, the respective retaining members 50 are turned through, e.g., 45 degrees to cause deformation of the perimeter wall delimiting the hole 32 of each hollow protrusion 31 and the perimeter wall delimiting the associated groove 23, as the distance between two diagonally opposed corners 53 of the retaining member 50 is greater than the length of the side of the hole 32 of the associated hollow protrusion 31. Thus, the friction between each hollow protrusion 31 and the perimeter wall delimiting the associated groove 23 is increased to reliably retain the second member 30 in place.

The outer perimeter of the first member 20 and the outer perimeter of the second member 30 can be bonded together by means of high frequency wave heat pressing. Thus, the tools 21 in the tool receiving device 10 can be prevented from being stolen during display, and the user may cut the bonded area before use.

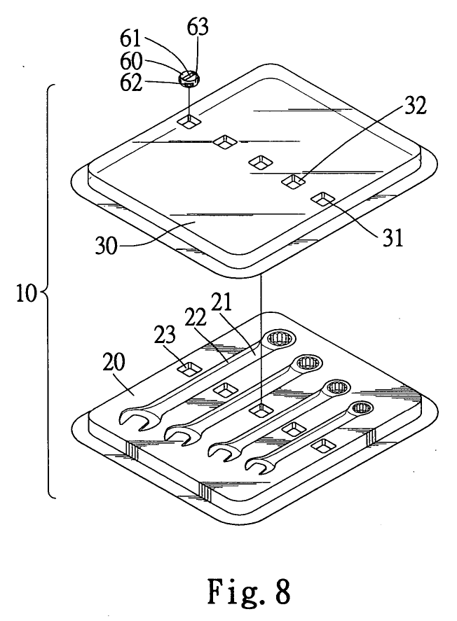

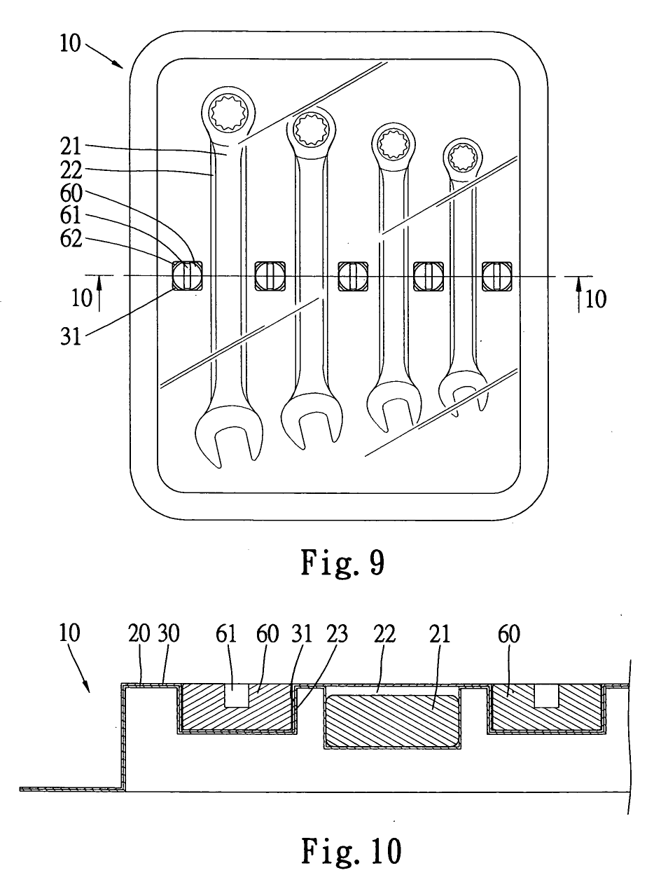

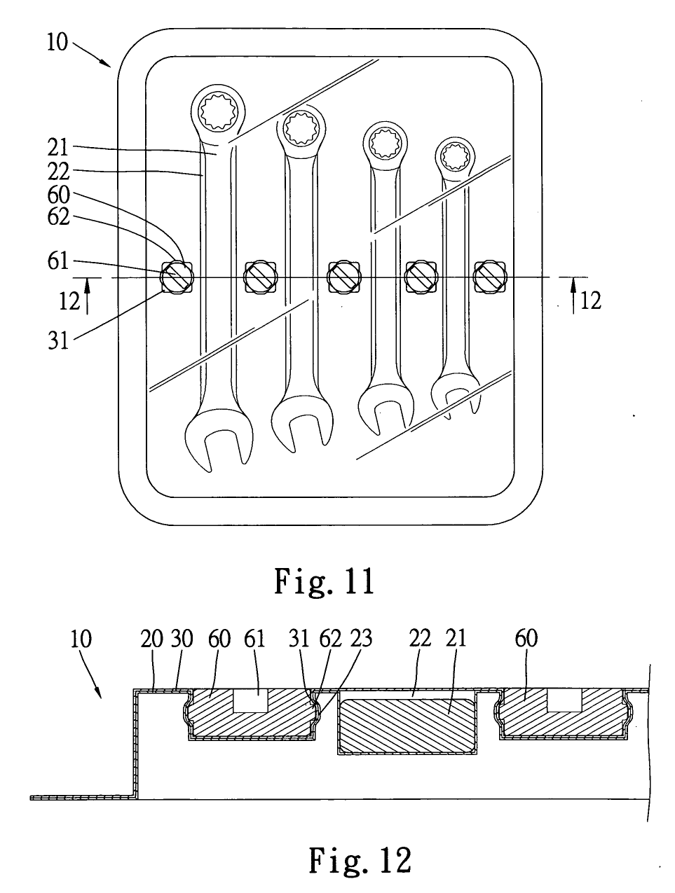

FIG. 8 is an exploded perspective view of a second embodiment of the tool receiving device in accordance with the present invention. FIG. 9 is a top view of the tool receiving device in FIG. 8. FIG. 10 is a sectional view taken along plane 10-10 in FIG. 9. FIG. 11 is a top view similar to FIG. 9, wherein the retaining elements are moved to a retaining position. FIG. 12 is a sectional view taken along plane 12-12 in FIG. 11.

In this embodiment, each retaining member 60 includes a slot 61 in a top side thereof for engaging with a slotted screwdriver. Further, each retaining member 60 includes a circumference 63 and at least one pair of diametrically disposed protrusions 62 formed on the circumference 63. Preferably, there are four protrusions 62 on the circumference 63 and spaced at 90 degrees interval. The diameter of the circumference 63 of the retaining member 60 is not greater than a length of the side of the hole 32 of the hollow protrusion 31. Nevertheless, the maximum diameter of the retaining member 60 (including the diametrically opposed protrusions 62) is greater than the length of the side of the hole 32 of the associated hollow protrusion 31 and smaller than a diagonal length of the hole 32 of the associated hollow protrusion 31.

As illustrated in FIGS. 9 and 10, the respective retaining members 60 are placed into the holes 32 of the respective hollow protrusions 31, with the protrusions 62 being located in four corners of the holes 32 of the respective hollow protrusions 31. The perimeter wall delimiting the hole 32 of each hollow protrusion 31 and the perimeter wall delimiting each groove 23 are not deformed, as the maximum diameter of the retaining member 60 is smaller than a diagonal length of the hole 32 of the associated hollow protrusion 31.

Referring to FIGS. 11 and 12, the respective retaining members 60 are turned through 45 degrees to cause deformation of the perimeter walls delimiting the holes 32 of the hollow protrusions 31 and the perimeter walls delimiting the respective grooves 23, as the maximum diameter of the retaining member 60 is greater than the length of the associated hole 32. Thus, the friction between the hollow protrusions 31 and the perimeter walls delimiting the respective grooves 23 is increased to reliably retain the second member 30 in place.

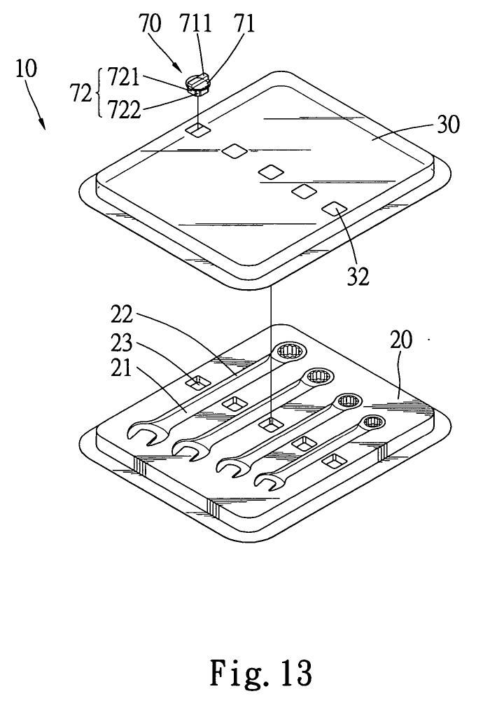

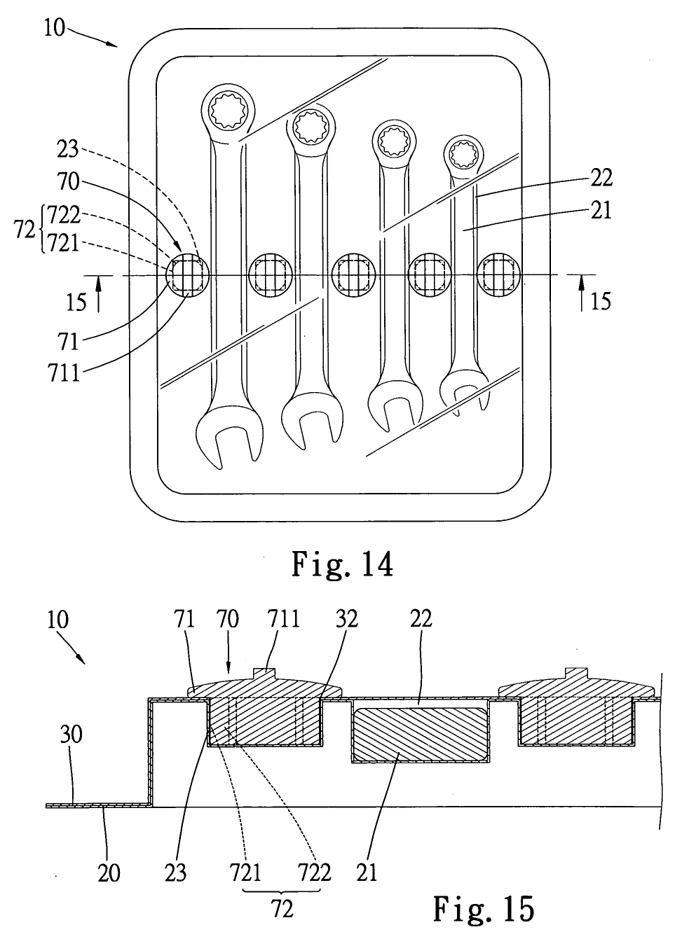

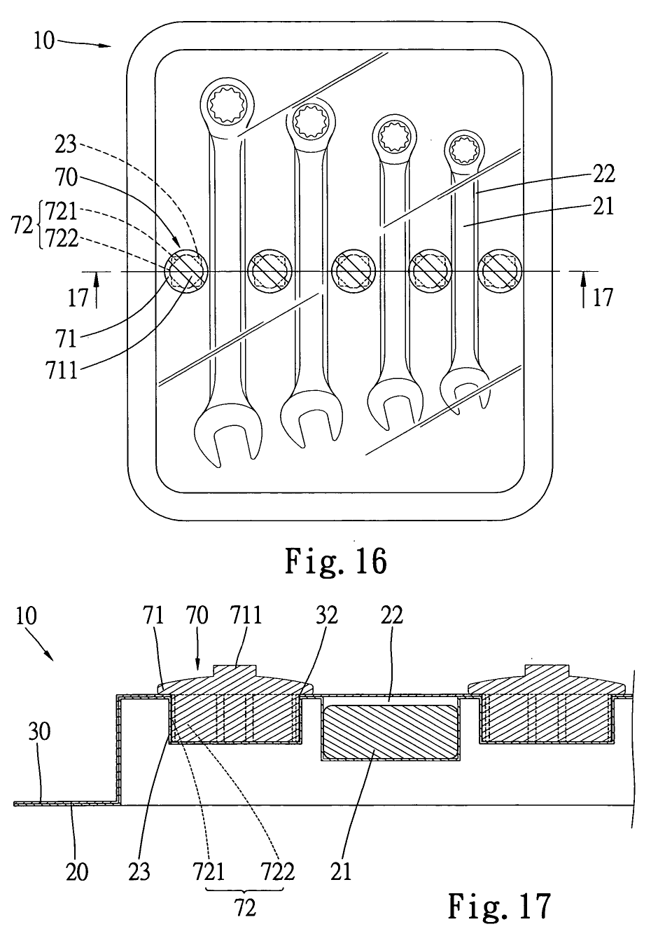

FIG. 13 is an exploded perspective view of a third embodiment of the tool receiving device in accordance with the present invention. FIG. 14 is a top view of the tool receiving device in FIG. 13. FIG. 15 is a sectional view taken along plane 14-14 in FIG. 13. FIG. 16 is a top view similar to FIG. 14, wherein the retaining elements are moved to a retaining position. FIG. 17 is a sectional view taken along plane 17-17 in FIG. 16.

In this embodiment modified, the hollow protrusions 31 of the first member 30 are omitted, yet the holes 31 (in the form of through-holes) are kept. Each retaining member 70 includes an enlarged first end 71 and a second end 72. The enlarged first end 71 of the retaining member 70 has a diameter greater than a length of the hole 32 of the second member 30 that is equal to a length of the groove 23 of the first member 20. Further, a turn piece 711 is formed on a top face of the enlarged first end 71 for manual turning. The second end 72 of the retaining member 70 is square and includes four sides 721 and four corners 722. Each side 721 has a length not greater than that of the associated groove 23 of the first member 20. Further, a distance between two diagonally opposed corners 722 is greater than the length of the associated groove 23 and smaller than a diagonal length of the associated groove 23 of the first member 20.

As illustrated in FIGS. 14 and 15, the respective retaining members 70 are inserted through the respective holes 32 of the second member 30 into the respective grooves 23 of the first member 20, with the enlarged first end 71 of each retaining member 70 being located outside the associated hole 32 of the second member 30. The perimeter wall delimiting each groove 23 of the first member 20 is not deformed, as each side 721 of the second end 72 of the associated retaining member 70 has a length not greater than that of the groove 23 of the first member 20 and as the distance between two diagonally opposed corners 722 is smaller than the diagonal length of the associated groove 23 of the first member 20. The second member 30 can be easily disengaged from the first member 20.

Referring to FIGS. 16 and 17, each retaining member 70 can be turned through 45 degrees. Since the distance between two diagonally opposed corners 722 is greater than the length of the associated groove 23, the perimeter wall delimiting the associated groove 23 deforms outward. Thus, the second member 30 is reliably retained in place by the friction between the perimeter wall delimiting each groove 23 of the second member 20 and the circumference of the second end 72 of the associated retaining member 70. Disengagement of the second member 30 from the first member 20 is prevented by the enlarged first ends 71 of the retaining members 70.

Access to the tools 21 can be easily achieved by means of removing the retaining members 70 from the grooves 23 of the first member 20 and then disengaging the second member 30 from the first member 20. The turn piece 711 on each retaining member 70 allows easy grip and turning.

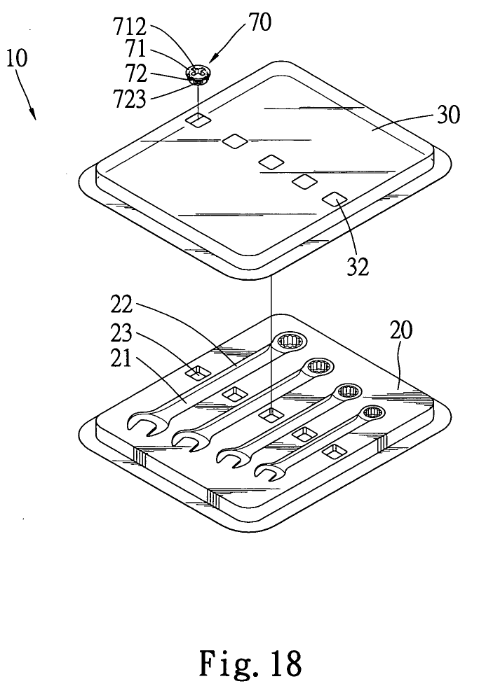

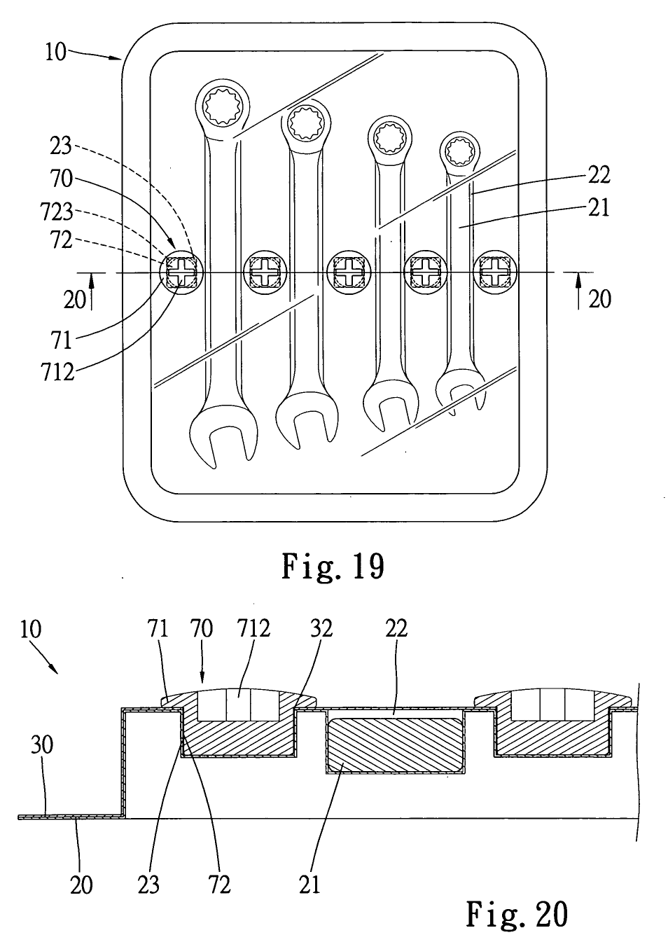

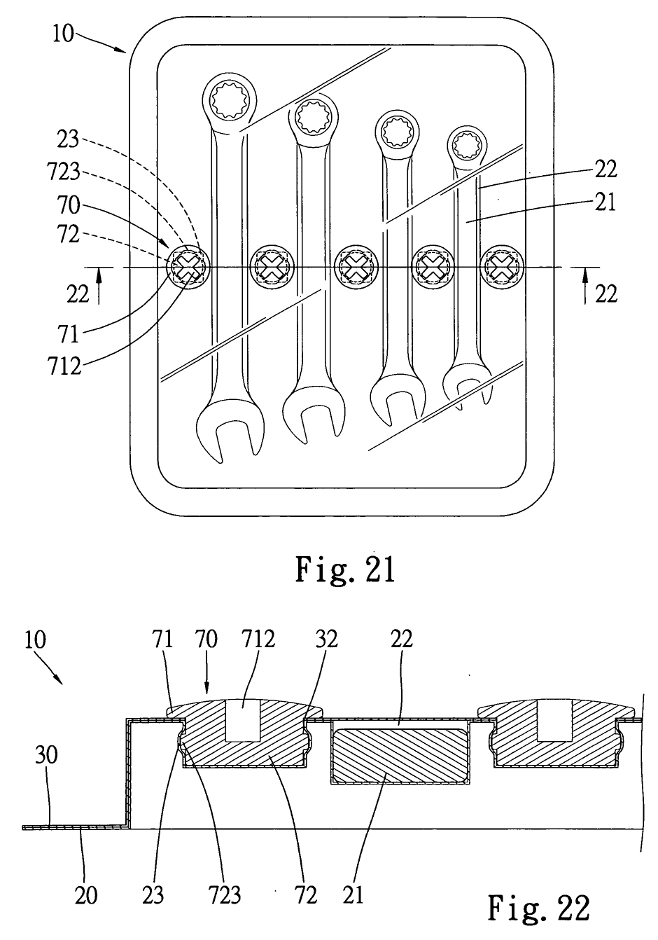

FIG. 18 is an exploded perspective view of a fourth embodiment of the tool receiving device in accordance with the present invention. FIG. 19 is a top view of the tool receiving device in FIG. 18. FIG. 20 is a sectional view taken along plane 20-20 in FIG. 19. FIG. 21 is a top view similar to FIG. 19, wherein the retaining elements are moved to a retaining position. FIG. 22 is a sectional view taken along plane 22-22 in FIG. 21.

In this embodiment modified from the third embodiment, each retaining member 70 includes an enlarged first end 71 and a second end 72. The enlarged first end 71 of the retaining member 70 has a diameter greater than a width of the hole 32 of the second member 30 that is equal to a length of the groove 23 of the first member 20. Further, a cruciform slot 712 is defined in a top face of the enlarged first end 71 for engaging with, e.g., a Phillip screwdriver, allowing easy turning of the retaining member 70. The second end 72 of the retaining member 70 is circular and includes two pairs of diametrically opposed protrusions 723. The second end 72 of the retaining member 70 has a diameter not greater than the length of the associated groove 23 of the first member 20. Further, the maximum diameter of the second end 72 of the retaining member 70 is greater than the length of the associated groove 23 and smaller than a diagonal length of the associated groove 23 of the first member 20.

As illustrated in FIGS. 19 and 20, the respective retaining members 70 are inserted through the respective holes 32 of the second member 30 into the respective grooves 23 of the first member 20, with the enlarged first end 71 of each retaining member 70 being located outside the associated hole 32 of the second member 30. The perimeter wall delimiting each groove 23 of the first member 20 is not deformed, as the maximum diameter of the second end 72 of the retaining member 70 is smaller than the diagonal length of the associated groove 23 of the first member 20. The second member 30 can be easily disengaged from the first member 20.

Referring to FIGS. 21 and 22, each retaining member 70 can be turned through 45 degrees. Since the maximum diameter of the second end 72 of the retaining member 70 is greater than the length of the associated groove 23, the perimeter wall delimiting the associated groove 23 deforms outward. Thus, the second member 30 is reliably retained in place by the friction between the perimeter wall delimiting each groove 23 of the second member 20 and the circumference of the second end 72 of the associated retaining member 70. Disengagement of the second member 30 from the first member 20 is prevented by the enlarged first ends 71 of the retaining members 70.

Access to the tools 21 can be easily achieved by means of removing the retaining members 70 from the grooves 23 of the first member 20 and then disengaging the second member 30 from the first member 20.

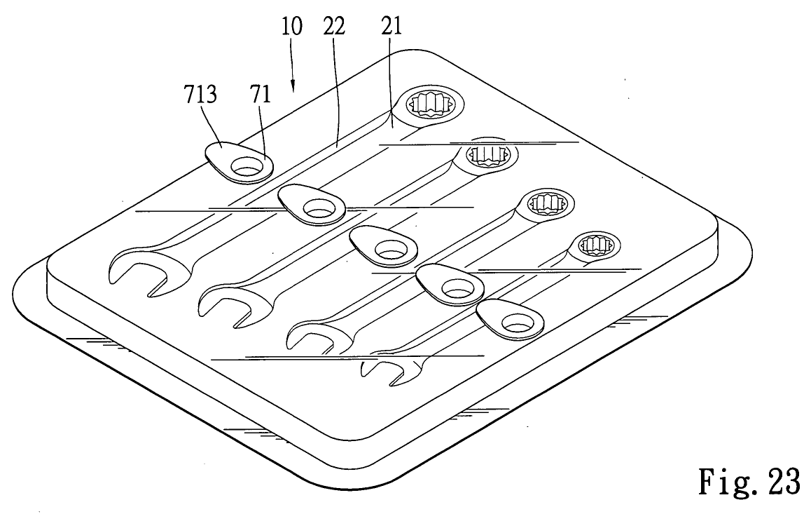

FIG. 23 is a perspective view of a fifth embodiment of the tool receiving device modified from the third embodiment. In this embodiment, the enlarged first end 71 of each retaining member 70 includes an extension 713 to allow easy grip and turning. This embodiment can be applied to the first embodiment through the fourth embodiment to replace the turn piece 51, 71 and the slot 61, 712.

Although the invention has been explained in relation to its preferred embodiments, it is to be understood that many other possible modifications and variations can be made without departing from the scope of the invention as hereinafter claimed.

1. A tool receiving device comprising:
a first member made of a deformable material and including at least one tool receiving compartment and at least one groove in a side thereof;
a second member made of a deformable material and including at least one hole, said at least one hole of the second member being aligned with said at least one groove when the second member is engaged with the first member and thus covers said at least one tool receiving compartment and at least one groove; and
at least one retaining member separate from the first member and the second member;
said at least one retaining member being mountable into said at least one hole of the second member and said at least one groove of the first member and turnable from between a non-retaining position allowing disengagement of the second member from the first member and a retaining position not allowing disengagement of the second member from the first member.

2. The tool receiving device as claimed in claim 1, with the second member including a hollow protrusion extending from a perimeter wall delimiting said at least one hole of the second member, the hollow protrusion including a perimeter wall, the hollow protrusion being received in said at least one groove of the first member when the second member is engaged with the first member, the perimeter wall of the hollow protrusion of the second member and a perimeter wall delimiting said at least one groove of the first member deforming outward and in friction contact with each other when said at least one retaining member is in the retaining position.

3. The tool receiving device as claimed in claim 2, with said at least one retaining member including four sides and four corners, a length of each said side of said at least one retaining member being not greater than that of a side of said at least one hole of the second member, a distance between two of the corners that are diagonally disposed being greater than the length of the side of said at least one hole of the second member and smaller than a diagonal length of said at least one hole of the second member.

4. The tool receiving device as claimed in claim 3, with said at least one retaining member including a turn piece on a top side thereof.

5. The tool receiving device as claimed in claim 3, with said at least one retaining member including an extension.

6. The tool receiving device as claimed in claim 2, with said at least one retaining member including a circumference and at least one pair of diametrically disposed protrusions formed on the circumference and defining a maximum diameter, a diameter of the circumference being not greater than a length of side of said at least one hole of the second member, the maximum diameter of said at least one retaining member being greater than the length side of said at least one hole of the second member and smaller than a diagonal length of said at least one hole of the second member.

7. The tool receiving device as claimed in claim 6, with said at least one retaining member including a slot in a top side thereof.

8. The tool receiving device as claimed in claim 6, with said at least one retaining member including an extension.

9. The tool receiving device as claimed in claim 1, with said at least one retaining member including an enlarged first end having a diameter greater than a length of a side of said at least one hole, said at least one retaining member further including a second end that is received in said at least one groove of the first member, the second end of said at least one retaining member including four sides and four corners, a length of each said side of said at least one retaining member being not greater than that of the side of said at least one groove of the first member, a distance between two of the corners that are diagonally disposed being greater than the length of side of said at least one groove of the first member and smaller than a diagonal length of said at least one groove of the first member.

10. The tool receiving device as claimed in claim 9, with said at least one retaining member including a turn piece on a top side thereof.

11. The tool receiving device as claimed in claim 9, with said at least one retaining member including an extension.

12. The tool receiving device as claimed in claim 1, with said at least one retaining member an enlarged first end having a diameter greater than a length of a side of said at least one hole, said at least one retaining member further including a second end that is received in said at least one groove of the first member, the second end of said at least one retaining member including a circumference and at least one pair of diametrically disposed protrusions formed on the circumference and defining a maximum diameter, a diameter of the circumference being not greater than a length of a side of said at least one groove of the first member, the maximum diameter of said at least one retaining member being greater than a length of the side of said at least one groove of the first member and smaller than a diagonal length of said at least one groove of the first member.

13. The tool receiving device as claimed in claim 12, with the enlarged first end of said at least one retaining member including a slot in a top face thereof.

14. The tool receiving device as claimed in claim 12, with the enlarged first end of said at least one retaining member including a cruciform slot in a top face thereof.

15. The tool receiving device as claimed in claim 12, with said at least one retaining member including an extension.

16. The tool receiving device as claimed in claim 1, with the first member being a plastic casing.

17. The tool receiving device as claimed in claim 1, with the second member being a plastic casing.

18. The tool receiving device as claimed in claim 1, with said at least one groove of the first member being square.

19. The tool receiving device as claimed in claim 1, with said at least one hole of the second member being square.

20. The tool receiving device as claimed in claim 1, with the first member including an outer perimeter bonded with an outer perimeter of the second member by high frequency wave heat pressing.
